(19) United States
(12) Patent Application Publication
(10) Pub. No.: US 2023/0258671 A1
(43) Pub. Date: Aug. 17, 2023

(54) LABORATORY SYSTEM

(71) Applicant: Roche Diagnostics Operations, Inc., Indianapolis, IN (US)

(72) Inventors: Markus Kollmer, Stuttgart (DE); Yanis Ali Mahmoud, Munich (DE); Michael Rein, Fellbach (DE); Teodor Laurentiu Vasile, Munich (DE)

(73) Assignee: Roche Diagnostics Operations, Inc., Indianapolis, IN (US)

(21) Appl. No.: 18/168,679

(22) Filed: Feb. 14, 2023

(30) Foreign Application Priority Data
Feb. 17, 2022 (EP) 22157371.0

(51) Int. Cl. G01N 35/00

(52) U.S. Cl. CPC G01N 35/00732; G01N 2035/00742; G01N 2035/00752

(57) ABSTRACT

A laboratory system, comprising: at least one rack comprising retainers, wherein the rack is adapted to carry laboratory sample containers inserted in the retainers, a handling device, wherein the handling device is adapted to insert sample containers in the retainers or remove containers from the retainers being placed at a processing position depending on location information indicating the location of the rack being placed at the processing position relative to the handling device, a plurality of teaching devices, wherein a respective teaching device is insertable into a retainer of the rack, and wherein at least two teaching devices are inserted into a corresponding retainer of the rack being placed at the processing position, and a location information calculating device, wherein the calculating device is adapted to calculate the location information of the rack being placed at the processing position depending on the location of the at least two teaching devices.

### CROSS-REFERENCE TO RELATED APPLICATIONS

This application claims priority to European Patent Application No. 22157371.0, filed 17 Feb. 2022, the disclosure of which is hereby incorporated by reference in its entirety.

### TECHNICAL FIELD

The disclosure relates to a laboratory system.

### BACKGROUND

So called in-sorters and out-sorters are laboratory systems used in laboratory automation. The function of an in-sorter or out-sorter is the handling of laboratory sample containers comprising samples to be processed, e.g., by a laboratory station. The in-sorter transfers laboratory sample containers from a container storing position to a sample container transport unit. The sample container transport unit transports the laboratory sample containers to a corresponding laboratory station for processing samples comprised in the laboratory sample containers. The processed samples are transported by the sample container transport unit to the out-sorter. The out-sorter transfers the laboratory sample containers from the sample container transport unit to a storing position.

The laboratory sample containers are often stored in racks, wherein a rack is adapted to store a certain number of laboratory sample containers. The number of laboratory sample containers to be stored depends on the type of the rack. The in-sorter is adapted to remove the laboratory sample containers from a container storing position inside the rack and transfer them to the sample container transport unit. Typically, an empty rack is placed in the out-sorter, wherein laboratory sample containers comprising processed samples are inserted into this rack.

For removing laboratory sample containers from the rack or inserting laboratory sample containers in the rack the in-sorter and out-sorter need to know the position and the type of a rack, i.e., the position and the number of possible storing positions for laboratory sample containers. Thus, according to the prior art, when an in-sorter and an out-sorter are brought into service the type of the rack and possible rack positions have to be transferred to and stored in the sorter for correctly gripping a laboratory sample container.

It is against the above background that aspects of the present disclosure provide certain unobvious advantages and advancements over the prior art. In particular, a need was recognized for improvements in a laboratory system.

### SUMMARY

In accordance with one embodiment of the present disclosure, a laboratory system is provided, comprising: at least one rack comprising retainers, wherein the at least one rack is adapted to carry laboratory sample containers inserted in the retainers, and a handling device, wherein the handling device is adapted to insert laboratory sample containers in the retainers of the at least one rack or remove laboratory sample containers from the retainers of the at least one rack being placed at a processing position depending on location information indicating the location of the at least one rack being placed at the processing position relative to the handling device, wherein the laboratory system further comprises: a plurality of teaching devices, wherein a respective teaching device is geometrically formed such that it is insertable into a retainer of the at least one rack, and wherein at least two teaching devices are inserted into a corresponding retainer of the at least one rack being placed at the processing position, and a location information calculating device, wherein the location information calculating device is adapted to calculate the location information of the at least one rack being placed at the processing position depending on the location of the at least two teaching devices.

These and other features and advantages of the embodiments of the present disclosure will be more fully understood from the following detailed description taken together with the accompanying claims. It is noted that the scope of the claims is defined by the recitations therein and not by the specific discussions of features and advantages set forth in the present description.

### BRIEF DESCRIPTION OF THE DRAWINGS

The following detailed description of the embodiments of the present description can be best understood when read in conjunction with the following drawings, where like structure is indicated with like reference numerals and in which:

FIG. 1 schematically depicts a top view on a laboratory system according to a first embodiment;

FIG. 2 schematically depicts a side view on the laboratory system according to the first embodiment;

FIG. 3 depicts a teach in workflow of the laboratory system of FIG. 1 and FIG. 2; and

FIG. 4 schematically depicts a laboratory system according to a further embodiment.

Skilled artisans appreciate that elements in the figures are illustrated schematically for simplicity and clarity and have not necessarily been drawn to scale. For example, the dimensions of some of the elements in the figures may be exaggerated relative to other elements to help improve understanding of the aspects of the present disclosure.

### DETAILED DESCRIPTION

The laboratory system comprises at least one rack comprising retainers, wherein the at least one rack is adapted to carry laboratory sample containers inserted in the retainers. Reference insofar is made to the corresponding prior art. The number of laboratory sample containers carried by the respective rack may, e.g., be a number in the range of 2 up to 150.

The laboratory system further comprises a handling device, e.g., in form of a conventional gripping device or pick-and-place device. The handling device is conventionally adapted to insert laboratory sample containers in the retainers of the rack or to remove laboratory sample containers from the retainers of the rack, when the rack is placed at a dedicated processing position. The handling device handles the laboratory sample containers depending on location information indicating the location of the rack being placed at the processing position relative to the handling device. The location information may, e.g., be formed by x- and y-coordinates of a coordinate system of the handling device indicating a specific position of/on the rack, e.g., an edge, a specific retainer, etc.

The laboratory system further comprises a plurality of teaching devices, e.g., between 2 and 100 teaching devices, wherein a respective teaching device is geometrically formed such that it is insertable into a retainer of a rack. A respective teaching device may, e.g., be formed like a laboratory sample container.

At least two, in particular at least three or exactly three, teaching devices are, e.g., manually inserted into a corresponding retainer of a rack being placed at the processing position before a teach in. The retainers receiving the teaching devices are defined and known.

The laboratory system further comprises a location information calculating device, e.g., in form of a computer, wherein the location information calculating device is adapted to calculate the location information of the rack being placed at the processing position depending on a measured location of the at least two teaching devices.

According to an embodiment a respective teaching device comprises a conventional RFID tag, wherein at least three teaching devices are inserted into a defined corresponding retainer of the rack being placed or to be placed at the processing position. The location information calculating device comprises a conventional RFID reader communicating with the RFID tags.

According to an embodiment the RFID reader is adapted to determine distances between the RFID reader and the at least three teaching devices, wherein the location information calculating device is adapted to calculate the location information of the rack using conventional multi-lateration based on the determined distances.

According to an embodiment the RFID reader is adapted to determine angles, in particular in a RFID reader coordinate system, between the RFID reader and the at least three teaching devices, wherein the location information calculating device is adapted to calculate the location information of the rack also using triangulation based on the determined angles.

According to an embodiment the RFID reader is attached to the handling device, in particular in a moving part of the handling device being moved during a handling operation.

According to an embodiment the RFID tags are battery powered, i.e., are active RFID tags.

According to an embodiment the location information calculating device comprises a digital camera, wherein the digital camera is adapted to take a digital image of the rack and of the teaching devices being inserted into the corresponding retainers of the rack being placed at the processing position, wherein the location information calculating device is adapted to calculate the location information based on the digital image.

According to an embodiment a respective teaching device comprises a mark visible by the digital camera. The mark may, e.g., be embodied as a QR-code, a barcode, a color, a printed code comprising numbers and/or letters, e.g., provided on a label or sticker.

According to an embodiment the laboratory system further comprises at least one laboratory station, wherein at least one laboratory station is adapted to perform a type of processing of samples being comprised in the laboratory sample containers. The laboratory stations may be, e.g., pre-analytical, analytical and/or post-analytical stations. Pre-analytical stations may be adapted to perform any kind of pre-processing of samples and/or laboratory sample containers. Analytical stations may be adapted to use a sample or part of the sample and/or a reagent to generate a measuring signal, the measuring signal indicating if and in which concentration an analyte exists. Post-analytical stations may be adapted to perform any kind of post-processing of samples and/or sample containers. The pre-analytical, analytical and/or post-analytical stations may comprise at least one of a decapping station, a recapping station, an aliquot station, a centrifugation station, an archiving station, a pipetting station, a sorting station, a tube type identification station, a sample quality determining station, an add-on buffer station, a liquid level detection station, and a sealing/desealing station.

In order that the embodiments of the present disclosure may be more readily understood, reference is made to the following examples, which are intended to illustrate the disclosure, but not limit the scope thereof.

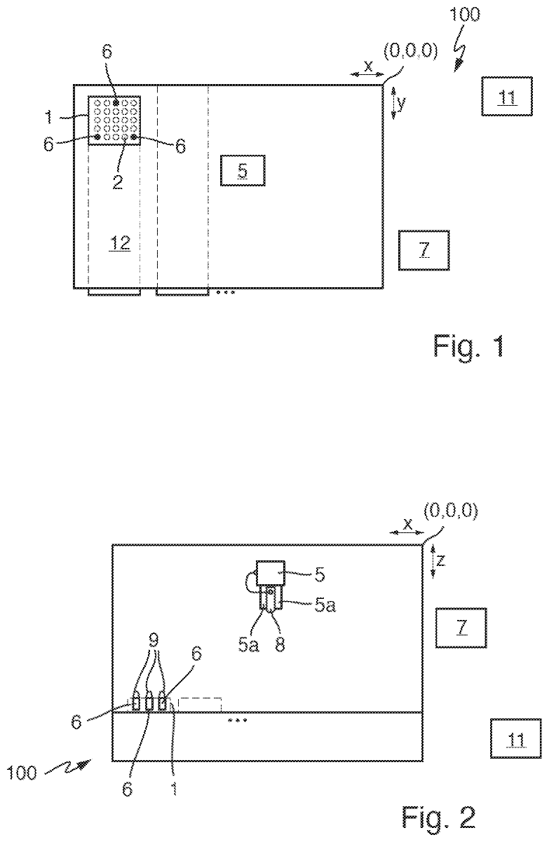

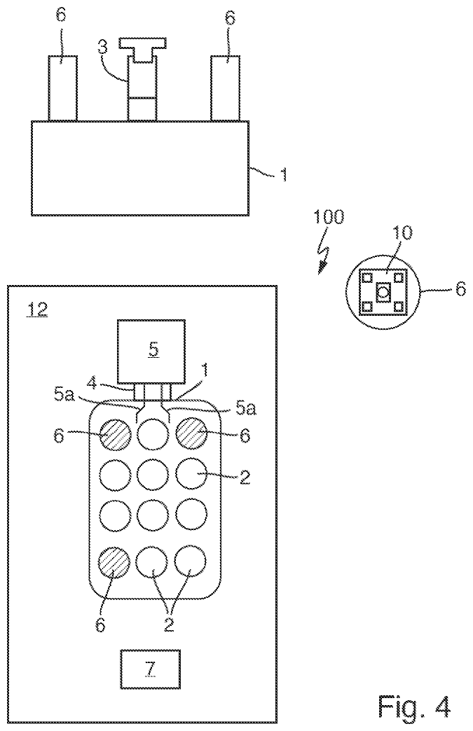

FIG. 1 schematically depicts a top view on a laboratory system 100 comprising a rack 1 having retainers 2, wherein the rack 1 is adapted to carry or receive laboratory sample containers 3 (see FIG. 4) inserted in the retainers 2. FIG. 2 schematically depicts a side view on the laboratory system 100.

The laboratory system 100 comprises a handling device 5 in form of a conventional pickand-place device comprising a conventional gripping device 5a being movable in x-, y- and zdirection. The handling device 5 is adapted to insert laboratory sample containers 3 in the retainers 2 of the rack 1 or to remove laboratory sample containers 3 from the retainers 2 of the rack 1 when the rack 1 is placed at a processing position. The handling is done depending on location information indicating the location in x- and y-coordinates (and eventually z-coordinates) of the rack 1 being placed at the processing position. The x-, y- and z-coordinates denote the location of the rack 1 in a coordinate system of the handling device 5.

The rack 1 is located at the processing position inside a dedicated pick-and-place area 12 of the laboratory system 100 used for an in-sort operation or an out-sort operation. Initially, the exact location of the rack 1 within the pick-and-place area 12 is not known. By means of the disclosure the exact location of the rack 1 and thus of the retainers 2 of the rack 1 can be easily determined as will be described in detail below.

For that purpose, the laboratory system 100 further comprises three teaching devices 6 used, in particular only, during teach-in, wherein a respective teaching device 6 is geometrically formed such that it is insertable into a retainer 2 of the rack 1. As shown, the teaching devices 6 are inserted into dedicated and known retainers 2 of the rack 1, i.e., at specific positions in the rack 1. E.g., for a standard rack 1 of 5 columns and 10 rows the teaching devices 6 could be placed like depicted. The placement of the teaching devices 6 in the rack 1 for a specific and known shape/type of rack for performing a teach in is a prior known and well defined.

The laboratory system 100 further comprises a location information calculating device 7, wherein the location information calculating device 7 is adapted to calculate the location information or location of the rack 1 being placed at the processing position depending on the respective locations of the teaching devices 6.

For that purpose, the teaching devices 6 respectively comprise an active RFID tag 9 and the location information calculating device 7 comprises a RFID reader 8.

The RFID tags 9 may store information regarding the type of the rack 1, i.e., information regarding the geometrical size of the rack 1, the number and relative locations of the retainers 2, etc.

The RFID reader 8 is adapted to determine a respective distance between the RFID reader 8 and the teaching devices 6, wherein the location information calculating device 7 is adapted to calculate the location information of the rack 1 using multilateration based on the determined respective distances. The RFID reader 8 measures the signal strength of the signals received by the RFID tags 9. For a 2-dimensional positioning range measurement at least three RFID tags 9 are necessary. The respective distance between the RFID reader 8 and the RFID tags 9 is deduced from the conversion of signal strength into distances.

In addition, the RFID reader 8 may be adapted to determine a respective angle in a x-y-plane between the RFID reader 8 and the teaching devices 6, wherein the location information calculating device 7 may be adapted to calculate the location information of the rack 1 alternatively or in addition using triangulation based on the determined respective angles.

The RFID reader 8 or an antenna of the RFID reader 8 is, in particular only during teach in, attached to the handling device 5, and may, e.g., be gripped by the gripping device 5a during teach in.

The depicted laboratory system 100 uses, inter alia, multi-lateration or trilateration and/or multi-angulation or triangulation for calculating the absolute coordinates of the rack 1 and thus of sample container carriers 3 received by the rack 1 relative to a so-called homing position (0, 0, 0) in x-, y- and z-coordinates of the handling device 5.

During teach in, the gripping device 5a together with the RFID reader 8 is initially moved to a center position within the pick-and-place area 12, e.g., at a half distance of the maximum range for a planar axis system.

Three RFID tags 9 per rack 1 are used to perform triangulation/trilateration and to calculate the absolute coordinates of the rack 1. The active RFID tags 9 mounted inside of the teaching devices 6 are powered by an internal rechargeable battery. The internal rechargeable batteries may, e.g., be inductively charged.

For the triangulation/trilateration to work reliably the signal strength and the angle of arrival of the signal of the RFID tags 9 are used.

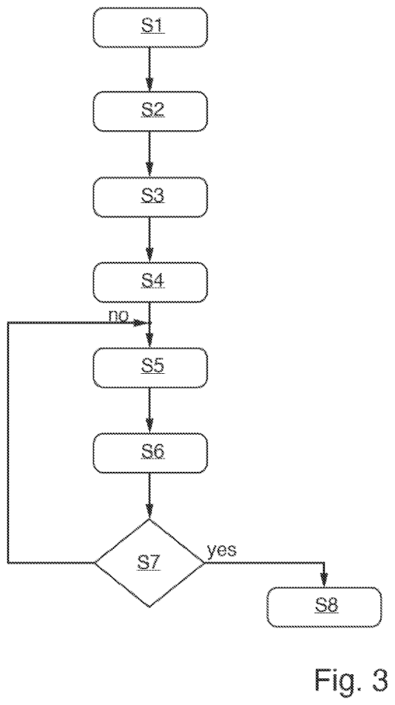

Referring now to FIG. 3, the teach in may comprise the following steps:
S1: An operator starts the teach in.
S2: The teaching devices 6 are e.g. manually inserted into the retainers 2 of the rack 1 located on or to be located on the pick-and-place area 12. For rectangular racks 1 three tags are necessary/sufficient. The RFID reader 8 is fixed to/by the handling device 5.
S3: The handling device 5 is moved to the absolute coordinate (0,0,0) in a coordinate system of the handling device 5.
S4: The handling device 5 is moved to a central/middle position of the pick-and-place area 12, e.g. at the mid distance of the maximum permitted by the x- and y-axis system.
S5: From this middle position the RFID reader 8 starts the measurement, therefore the RFID reader 8 connects to the active RFID tags 9, and the active RFID tags 9 answer by communicating their unique tag ID.
S6: The RFID reader 8 measures the signal strength/signal angle of the associated active RFID tag 9. This procedure is repeated for all three active RFID tags 9 in the rack 1. Based on the measured signal strength/signal angle the location of the rack 1 is calculated using trilateration and/or triangulation.
S7: The RFID reader 8 continues the same type of measurement for all further racks 1, if any, placed within the pick-and-place area 12.
S8: The teach in is ended.

FIG. 4 schematically depicts a laboratory system 100 according to a further embodiment.

According to this embodiment the location information calculating device 7 comprises a spatially calibrated digital camera 4 replacing the RFID reader 8 of the embodiment depicted in FIG. 1 and FIG. 2, wherein the digital camera 4 is adapted to take a digital image of the rack 1 and of the teaching devices 6 being inserted into the corresponding retainers 2 of the rack 1 being placed at the processing position within the pick-and-place area 12. The location information calculating device 7 is adapted to calculate the location information based on the digital image.

The digital camera 4 may be attached to the handling device 5.

A respective teaching device 6 comprises a mark 10 visible by the digital camera 4. The mark 10 may, e.g., be a QR code also indicating the type of the rack 1. The positions of the teaching devices 6 extracted from the digital image together with rack specific data derived from the QR code may be used to calculate the position of the rack 1 and the positions of the retainers 2 of the rack 1.

During the setup of the laboratory system 100 the three teaching devices 6 are placed in a respective rack 1. For a dedicated rack 1 the teaching tools 6 may have the same mark 10 on top. If more than one rack 1 is teached in, each rack may have a specific mark 10. This may be realized by a QR code or a pattern for example. After the placement, the digital camera 4 is scanning the surface and recognizing all the marks 10. By means of the positions and the types of the marks the rack 1 can be identified and localized. If several racks have similar marks, a user can, e.g., choose the correct rack in an user interface.

The embodiments depicted in the figures depict a single rack 1. Self-evidently, the disclosure may be embodied in conjunction with more than one rack.

The laboratory system 100 further comprises at least one conventional laboratory station 11 being adapted to perform a type of processing of samples being comprised in the laboratory sample containers.

What is claimed is:

1. A laboratory system, comprising:
at least one rack comprising retainers, wherein the at least one rack is adapted to carry laboratory sample containers inserted in the retainers, and
a handling device, wherein the handling device is adapted to insert laboratory sample containers in the retainers of the at least one rack or remove laboratory sample containers from the retainers of the at least one rack being placed at a processing position depending on location information indicating the location of the at least one rack being placed at the processing position relative to the handling device,
wherein the laboratory system further comprises:
a plurality of teaching devices,
wherein a respective teaching device is geometrically formed such that it is insertable into a retainer of the at least one rack, and
wherein at least two teaching devices are inserted into a corresponding retainer of the at least one rack being placed at the processing position, and
a location information calculating device, wherein the location information calculating device is adapted to calculate the location information of the at least one rack being placed at the processing position depending on the location of the at least two teaching devices.

2. The laboratory system according to claim 1, wherein at least three teaching devices are inserted into a corresponding retainer of the at least one rack being placed at the processing position.

3. The laboratory system according to claim 1, wherein a respective teaching device comprises a RFID tag, at least three teaching devices are inserted into a corresponding retainer of the at least one rack being placed at the processing position, and the location information calculating device comprises a RFID reader.

4. The laboratory system according to claim 3, wherein the RFID reader is adapted to determine distances between the RFID reader and the at least three teaching devices, and wherein the location information calculating device is adapted to calculate the location information of the at least one rack using multilateration based on the determined distances.

5. The laboratory system according to claim 3, wherein the RFID reader is adapted to determine angles between the RFID reader and the at least three teaching devices, and wherein the location information calculating device is adapted to calculate the location information of the at least one rack using triangulation based on the determined angles.

6. The laboratory system according to claim 3, wherein the RFID reader is attached to the handling device.

7. The laboratory system according to claim 3, wherein the RFID tags are battery powered.

8. The laboratory system according to claim 1, wherein the location information calculating device comprises a digital camera, wherein the digital camera is adapted to take a digital image of the at least one rack and of the teaching devices being inserted into the corresponding retainers of the at least one rack being placed at the processing position, and wherein the location information calculating device is adapted to calculate the location information based on the digital image.

9. The laboratory system according claim 8, wherein a respective teaching device comprises a mark visible by the digital camera.

10. The laboratory system according claim 9, wherein the mark is a QR code.

11. The laboratory system according claim 10, wherein the QR code indicates the type of the at least one rack.

12. The laboratory system according to claim 1, wherein the laboratory system further comprises at least one laboratory station, wherein the least one laboratory station is adapted to perform a type of processing of samples being comprised in the laboratory sample containers.
